(19) United States
(12) Patent Application Publication
(10) Pub. No.: US 2009/0300009 A1
(43) Pub. Date: Dec. 3, 2009

(54) Behavioral Targeting For Tracking, Aggregating, And Predicting Online Behavior

(75) Inventors: Behnam A. Rezaei, Santa Clara, CA (US); Riccardo Boscolo, Culver City, CA (US); Nima Khajehnouri, Los Angeles, CA (US); Vwani P. Roychowdhury, Los Angeles, CA (US); Himawan Gunadhi, San Jose, CA (US)

Correspondence Address: NIXON PEABODY, LLP, 401 9TH STREET, NW, SUITE 900, WASHINGTON, DC, 20004-2128, US

(73) Assignee: NETSEER, INC., Santa Clara, CA (US)

(21) Appl. No.: 12/476,205

(22) Filed: Jun. 1, 2009

Related U.S. Application Data
(60) Provisional application No. 61/057,809, filed on May 30, 2008.

(51) Int. Cl. G06F 17/30

(52) U.S. Cl. 707/5; 707/10; 705/14.49; 707/E17.032; 707/E17.108

(57) ABSTRACT

A pre-computed concept map represents concepts, concept metadata, and relationships between the plurality of concepts. Online user behavior may be predicted by correlating one or more online events of a user with one or more features of the concept map, aggregating a concept map history of the user to obtain online behavior over time, aggregating online behavior of the user and one or more other users to obtain aggregated online user behavior, and predicting future online behavior of the user based at least in part on the online behavior of the user and the aggregated online user behavior. The predicted behavior may be used to target ads that the user is likely to find relevant.

### CROSS REFERENCE TO RELATED APPLICATIONS

This application claims the benefit of provisional patent application No. 61/057,809 filed May 30, 2008, entitled “Behavioral Targeting System and Method for Tracking, Aggregating and Predicting User's Online Behavior.”

This application is related to the following commonly assigned United States Patent Application filed on May 7, 2009:
Ser. No. 12/436,748, entitled “Discovering Relevant Concept and Context for Content Node” (Attorney Docket No. 050759-007000).

### FIELD OF THE INVENTION

The present invention relates to the field of computer science. More particularly, the present invention relates to behavioral targeting for tracking, aggregating, and predicting online behavior.

### BACKGROUND

Information retrieval systems are typically designed to retrieve relevant content from a data repository, based on inputs from users. The user input can be in any of the following example forms: (i) a set of keywords, (ii) single or multiple lists of URLs and domains, and (iii) a set of documents (e.g., text files, HTML pages, or other types of markup language content). A goal of such information retrieval systems is to pull the most relevant content (i.e., most relevant to the given input) from the underlying repository, which might itself comprise a heterogeneous set of structured and unstructured content. An example of the aforementioned information retrieval system is a traditional search engine, where a user provides a set of keywords, and the search engine provides simple ranked lists of top relevant web pages, and a separate list of top relevant paid listings or sponsored links. The set of web pages matching user's search queries and the advertisement database containing sponsored advertising materials are currently two separate databases that are processed very differently to pull the relevant pages and the sponsored links for the same user query. Thus, the conventional search engine described above provides an example of two distinct information repositories being processed in response to the same query.

Current systems find important keywords of a web page then try to expand them using various resources. This expanded set of keywords is compared with a user-provided set of keywords. One problem with such an approach is that keywords can have different meanings. For example, “Chihuahua” is a dog breed, but it is also a province in Mexico. In current systems, Chihuahua may expand to:
Chihuahua Breeders,
Travel to Chihuahua
Travel to Mexico
Chihuahua Puppy
Dog Training
Hotels in Chihuahua
Teacup Chihuahua Puppies
Cheap flights,

A person interested in a Chihuahua dog would find information about the Chihuahua province or travel to it less useful. And a person interested in the Chihuahua province would find information about dog training or a Chihuahua dog less useful.

Furthermore, a person searching for a Chihuahua dog for the first time would find information about Chihuahua breeders more useful. While a person searching for a Chihuahua dog several times over short time period may have already purchased a Chihuahua dog and would thus find information about dog training classes more useful.

Without knowing the context of the user-provided set of keywords, current systems often present search results that are irrelevant to what the user is seeking.

While the aforementioned systems allow for limited targeting of advertisement and content, such systems fail to provide efficient targeted advertisement avenues. Accordingly, a need exists for an improved solution for advertisement targeting.

### SUMMARY

The following summary of the invention is provided in order to provide a basic understanding of some aspects and features of the invention. This summary is not an extensive overview of the invention, and as such it is not intended to particularly identify key or critical elements of the invention, or to delineate the scope of the invention. Its sole purpose is to present some concepts of the invention in a simplified form as a prelude to the more detailed description that is presented below.

A pre-computed concept map represents concepts, concept metadata, and relationships between the plurality of concepts. Online user behavior may be predicted by correlating one or more online events of a user with one or more features of the concept map, aggregating a concept map history of the user to obtain online behavior over time, aggregating online behavior of the user and one or more other users to obtain aggregated online user behavior, and predicting future online behavior of the user based at least in part on the online behavior of the user and the aggregated online user behavior. The predicted behavior may be used to target ads that the user is likely to find relevant.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram that illustrates a system for predicting online behavior in accordance with one embodiment of the present invention.

FIG. 1A is a block diagram that illustrates predicting online behavior in accordance with one embodiment of the present invention.

FIG. 2 is a flow diagram that illustrates a method for predicting online behavior in accordance with one embodiment of the present invention.

FIG. 3 is a block diagram that illustrates possible uses for a system for predicting online behavior using aggregate user behaviors on a concept map and history of similar users in accordance with one embodiment of the present invention.

FIG. 4 is a flow diagram that illustrates a method for correlating online event with a concept map in accordance with one embodiment of the present invention.

FIG. 5 is a block diagram that illustrates a method for aggregating a user's concept map history and updating a behavioral profile in accordance with one embodiment of the present invention.

FIG. 6 is a block diagram that illustrates a method for inferring individual online user behavior based on aggregated online user behavior in accordance with one embodiment of the present invention.

FIG. 7 is a block diagram that illustrates a method for aggregating a user's detected behaviors to generate a behavioral concept map in accordance with one embodiment of the present invention.

FIG. 8 is a block diagram that illustrates a concept map in accordance with one embodiment of the present invention.

FIG. 9 is a block diagram that illustrates mapping online activities onto a concept map, and tracking behavior on the map in accordance with one embodiment of the present invention.

FIG. 10 is a block diagram that illustrates mapping online activities onto a concept map, and tracking behavior on the map in accordance with one embodiment of the present invention.

FIG. 11 is a block diagram that illustrates mapping online activities onto a concept map, and tracking behavior on the map in accordance with one embodiment of the present invention.

FIG. 12 is a block diagram of a computer system suitable for implementing aspects of the present invention.

### DETAILED DESCRIPTION

Embodiments of the present invention are described herein in the context of discovering relevant concepts and context for content nodes to determine a user's intent, and using this information to provide targeted advertisement and content. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

Embodiments of the present invention examine online activity of a group of users to determine what concepts are most closely associated with that online activity, and to determine a likelihood that one particular online activity will be followed by another particular online activity. The online activity of an individual user is compared to the group information to predict future online activity of the individual user.

For example, suppose a user visits a web page describing the “Chihuahua” dog breed, and the user has visited other similar web pages several times recently. The “Chihuahua” may expand to:
Chihuahua Breeders,
Travel to Chihuahua
Travel to Mexico
Chihuahua Puppy
Dog Training
Hotels in Chihuahua
Teacup Chihuahua Puppies
Cheap flights

But the current context relates to the Chihuahua dog, not the Chihuahua province. Furthermore, the user has been searching for a Chihuahua dog several times over short time period and may find have already purchased a Chihuahua dog.

According to embodiments of the present invention, online activity of a group of users is examined to determine what concepts are most closely associated with that online activity. In this case, the concepts are:
Chihuahua Breeders,
Chihuahua Puppy
Dog Training
Teacup Chihuahua Puppies

The online activity of the group of users further indicates that users searching for dogs several times over a short time period have likely purchase a dog, making “Dog Training” the concept most closely associated with the individual user's online activity. The user may be presented with content such as ads regarding dog training. Narrowly targeting specific ads to the user in this way increases the likelihood that the user will find the ads interesting, thus increasing their effectiveness.

In the context of the present invention, the term “content node” refers to one or more groupings of data. Example groupings of data include a web page, a paid listing, a search query, and a text file.

In the context of the present invention, the term “concept” refers to a unit of thought, expressed by a term, letter, or symbol. It may be the mental representation of beings or things, qualities, actions, locations, situations, or relations. A concept may also arise from a combination of other concepts. Example concepts include “diabetes,” “heart disease,” “socialism,” and “global warming.”

In the context of the present invention, the term “concept map” refers to a representation of concepts, concept metadata, and relationships between the concepts.

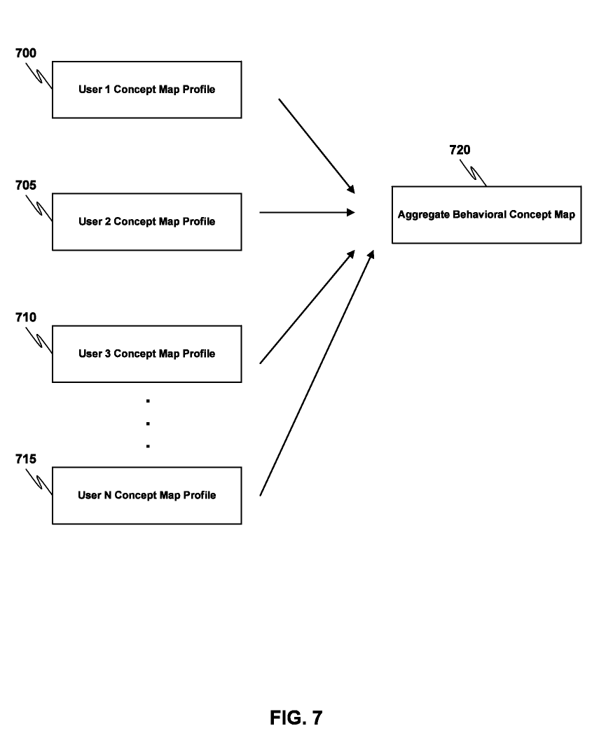

In the context of the present invention, the term “hub” refers to a node of a concept map that is connected to a relatively high number of edges. A hub represents a concept that is related to a relatively high number of other concepts. An example hub is “Greek God” 716 in FIG. 7.

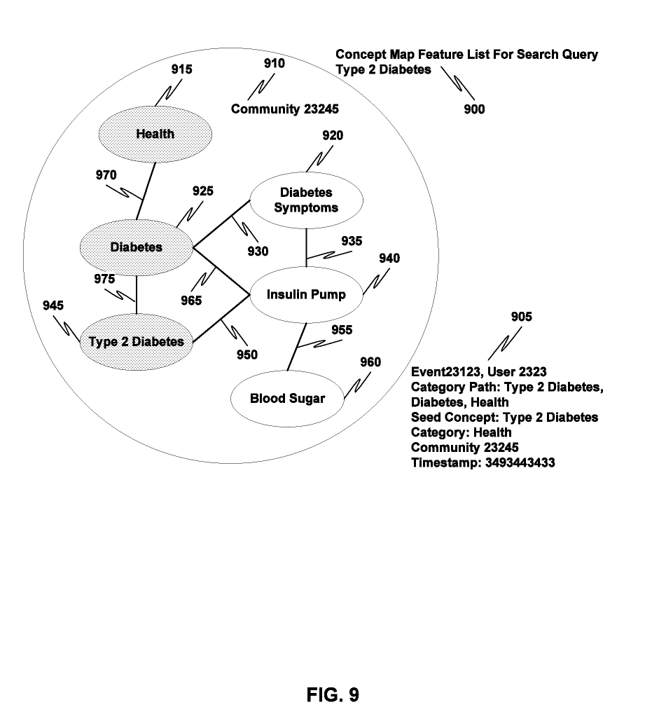

In the context of the present invention, the term “community” refers to a subgraph of a concept map. An example community is the “diabetes” community shown in FIG. 9.

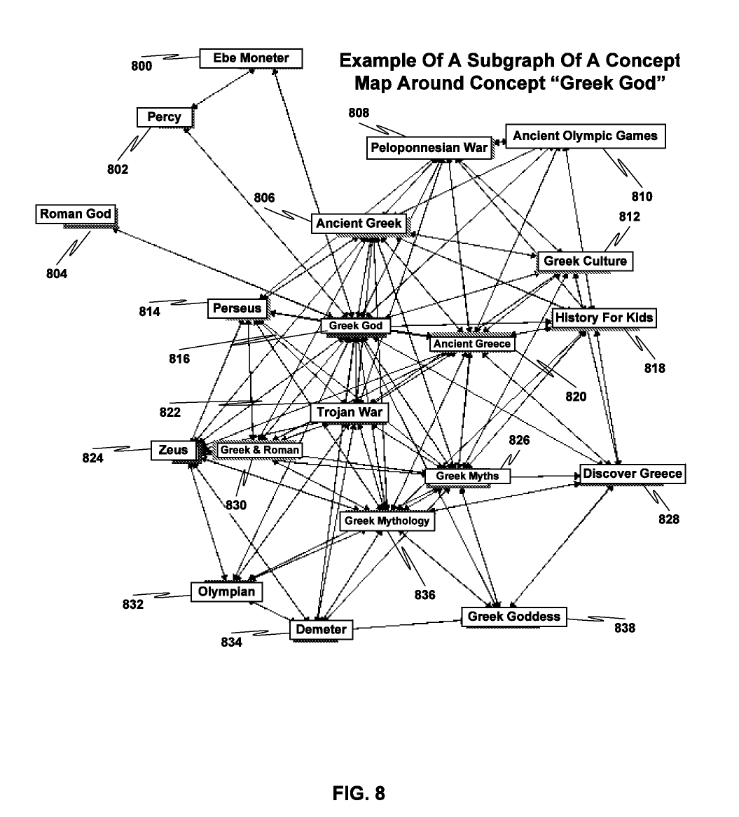

Embodiments of the present invention use a concept map which comprises concepts and their relationships. A concept map may be depicted as a graph, where each node of the graph represents a concept, and where each bidirectional multi edge between the nodes represents a relationship between the respective concepts. These relationships may include, for example, page co occurrence (frequency of the concepts occurring on the same page) or functional relationships as extracted from the World Wide Web, click through rates (CTRs) of advertisement, co occurrence in advertiser campaigns (frequency of the concepts occurring in the same advertiser campaign), co occurrence in advertisement creatives (frequency of the concepts occurring in the same advertisement creative), taxonomies and manually generated maps, user behavior such as query log funnels (queries submitted within a sequentially short period), and the like. An example of a concept map is shown in FIG. 8.

According to embodiments of the present invention, both nodes and edges of a concept map can have different attributes, and edges (relationships) can be bidirectional. Examples of node attributes include frequency on the Web, frequency on a particular corpus of documents, structural rank calculated on the graph itself, and cost per click (CPC) and CTR information of corresponding advertisement listings. Examples of different edge types and attributes include clickthrough rate of advertisement, user query rewrite rate (number of times a user requests the same information during a time period), and the like.

A concept map can be characterized by different types of information and associated features. For each node in the graph, a path to high level categories can be constructed. According to one embodiment of the present invention, for each node the pagerank, (As defined by Larry page and Sergei Brin in The PageRank Citation Ranking: Bringing Order to the Web (1998)) in the concept map is calculated and for each node the system calculates a path where next step of the path is the highest page rank node among first neighbors of the current node. This path is called a categorization path.

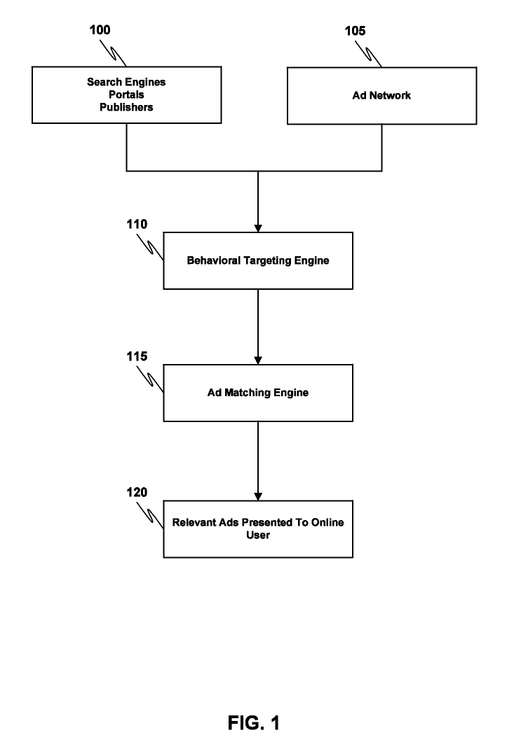

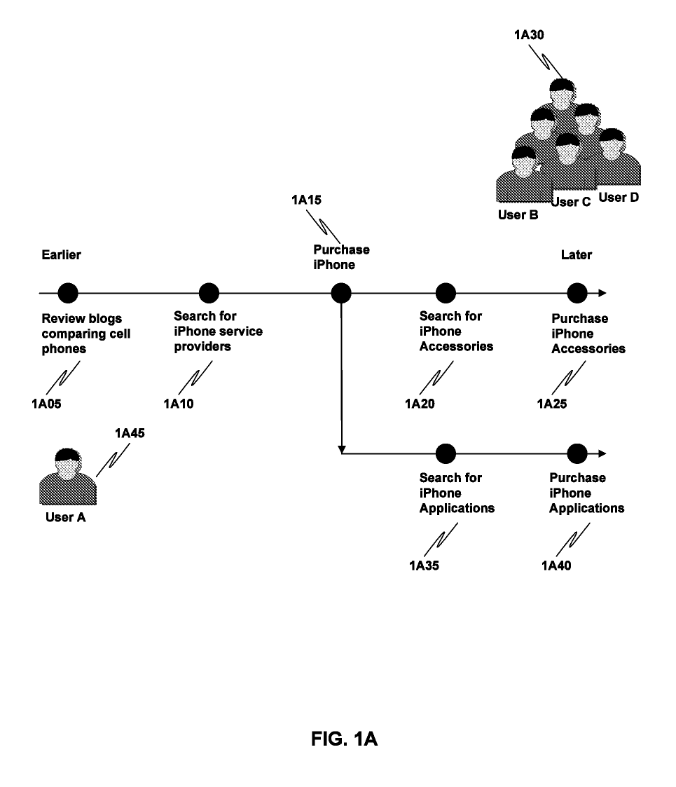

FIG. 1 is a block diagram that illustrates a system for predicting online behavior in accordance with one embodiment of the present invention. A behavioral targeting engine 110 may target an individual user of a search engine portal 100 for specific ads from an ad network 105. The targeting is based at least in part on the user's past online behavior and behavior of other users having similar past behavior. An ad matching engine 115 is configured to match information about the user's online behavior, with ads from ad network 105 to produce ads 120 that are likely to be relevant to the online user.

FIG. 1A is a block diagram that illustrates predicting online behavior in accordance with one embodiment of the present invention. FIG. 1A shows a timeline beginning with a user reviewing blogs comparing cell phones (1A05). At 1A10, the user searches for iPhone service providers. At 1A15, the user purchases an iPhone. After the user purchases an iPhone, the user customizes the iPhone by either searching for iPhone accessories (1A20) and then purchasing iPhone accessories (1A25), or by searching for iPhone applications (1A35) and then purchasing iPhone applications (1A40).

According to one embodiment of the present invention, a behavioral targeting engine obtains the sequence of events illustrated in FIG. 1A from an analysis of aggregated online user behavior of multiple users 1A30. Thus, when user A 1A45 has recently performed a task similar to reviewing blogs comparing cell phones (1A05), the behavioral targeting engine predicts that user A's future online events may include searching for iPhone service providers (1A10). If at a later time user A 1A45 has recently searched for iPhone service providers 1A10, a behavioral targeting engine predicts user A 1A45 may subsequently search for iPhone accessories (1A20) and then purchase iPhone accessories (1A25). Additionally, user A 1A45 may subsequently search for iPhone applications (1A35) and then purchase iPhone applications (1A40).

A behavioral targeting engine may target ads to user A 1A45 based upon user A's 1A45 predicted behavior. For example, after user A 1A45 has reviewed blogs comparing cell phones (1A05), the behavioral targeting engine may present ads from iPhone service providers, even before user A 1A45 searches for iPhone service providers. Thereafter, when the user has likely purchased an iPhone, the behavioral targeting engine may present ads related to iPhone accessories or iPhone applications.

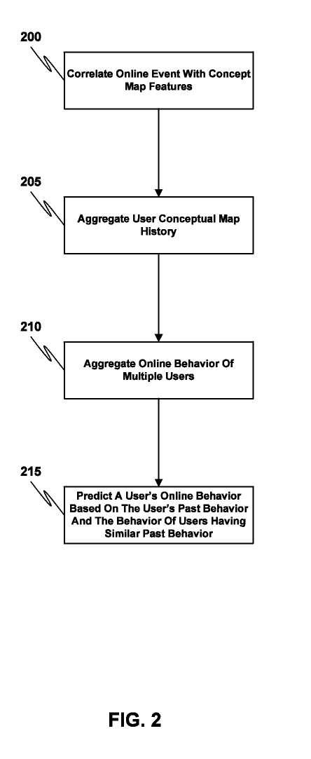

FIG. 2 is a flow diagram that illustrates a method for predicting online behavior in accordance with one embodiment of the present invention. At 200, one or more online events or activities are correlated with concept map features. Essentially, a user's online event is correlated with the concepts represented in the concept map. For example, a user search query concerning diabetes would correlate with portions of the concept map relating to diabetes. At 205, a user concept map history is aggregated to obtain a representation of the user's online behavior over time. For example, the aggregated user concept map history may show a user researched the iPhone several days ago, and recently researched service providers featuring the iPhone. At 210, online behavior of multiple users is aggregated to obtain aggregated online user behavior information. At 215, future online behavior of the user is predicted based at least on the user's past behavior and the behavior of one or more other users having similar past behavior. Examples of the aggregation processes are described below.

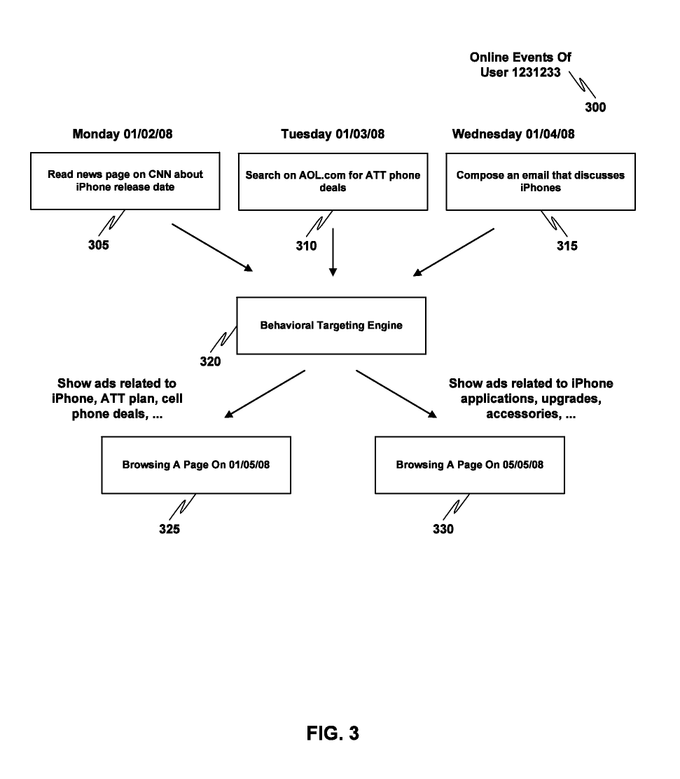

FIG. 3 is a block diagram that illustrates possible uses for a system for predicting online behavior using aggregate user behaviors on a concept map and history of similar users in accordance with one embodiment of the present invention. FIG. 3 shows how the online activities of an example user 300 are used to target ads that are likely to be of interest to the user. As shown in FIG. 3, on Monday (305), user 300 reads a news page on CNN concerning an iPhone release date. On Tuesday (310), user 300 searches the website AOL.com for ATT phone deals. And on Wednesday (315), user 300 composes an email that discusses iPhones. The user 300 activities on Monday (305), Tuesday (310), and Wednesday (315) are provided to behavioral targeting engine 320.

Using a concept map containing aggregated information regarding behavior of similar users, behavioral targeting engine 320 provides ads that are targeted to the user 300. The ads targeted to the user 300 may be based at least in part on the amount of time that has elapsed since one or more online events. Box 325 of FIG. 3 represents user 300 browsing a webpage only one day after composing an email that discusses iPhones (315). And box 330 represents user 300 browsing a webpage two months after composing an email that discusses iPhones (315). Based on the concept map containing aggregated information regarding behavior of similar users, behavioral targeting engine 320 knows that ads related to iPhones, service plans featuring the iPhone, and cell phone promotions are highly relevant to a user that has shown interest in but has probably not yet purchased an iPhone. Accordingly, when the user at 325 is browsing a webpage only one day after one or more online events indicating the user has probably not yet purchased an iPhone, the user is presented with ads related to iPhones, service plans featuring the iPhone, cell phone promotions, and the like.

Similarly, behavioral targeting engine 320 knows that ads related to iPhone applications, upgrades, and accessories are highly relevant to a user that has probably purchased an iPhone. Accordingly, when the user at 330 is browsing a webpage two months after online events indicating pre-purchase interest in the iPhone, the user is presented with ads related to iPhone applications, upgrades, accessories, and the like.

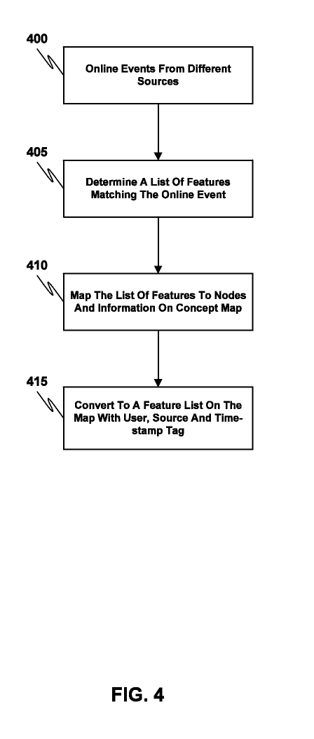

FIG. 4 is a flow diagram that illustrates a method for correlating online event with a concept map in accordance with one embodiment of the present invention. FIG. 4 provides more detail for reference numeral 200 of FIG. 2. Reference numeral 400 represents online event from various sources. User online events can be any interaction with a portal, for example searching for a keyword, browsing a webpage, reading emails, shopping, and any other online transaction. There are various systems to track users and generate user events using session ID, cookies, logging into the system, and others. Embodiments of the present invention do not depend on the method of acquisition of user event information.

At 405, the online event information is used to determine a list of features matching the input event. These features may include one or more keywords, one or more categories, and geographical information. The following example illustrates matching features for a search event where a user enters a query for “diabetes” at the website search.com:
Input: event: user 33242. Source: search.com, event: search, keyword: diabetes, timestamp: 01/04/08, 9:00 am, IP: 192.168.0.1,
Output: user 33242. Source: search.com, event: search, keyword: diabetes, timestamp: 01/04/08, 9:00 am, IP: 192.168.0.1, geolocation: los angeles, ca, user: 33242 source: search.com

The following example illustrates an example of matching features for a browsing event where a user browses a webpage regarding diabetes:
Input: event: user 33242. Source: bbc.com, event: browse, url: http://www.bbc.co.uk/health/healthy_living/nutrition/dietary_diabetes.shtml, timestamp: 01/04/08, 9:00 am, IP: 192.168.0.1,
Output: user 33242. Source: bbc.com, event: browse, url: http://www.bbc.co.uk/health/healthy_living/nutrition/dietary_diabetes.shtml, timestamp: 01/04/08, 9:00 am, IP: 192.168.0.1, keyword list: diabetes, type 2 diabetes, blood sugar, diabetes mellitus, health, for diabetes, category: health, geolocation: los angeles, ca

This mapping from events to initial feature list can be done using various methods. One such method for extracting top keywords for a page is described in commonly assigned U.S. patent application Ser. No. 12/436,748, entitled “Discovering Relevant Concept and Context for Content Node.” The aforesaid U.S. Patent Application is incorporated by reference herein in its entirety. The following example illustrates an example of matching features for a transaction event where the user is shopping for an iPhone at amazon.com:
Input: event: user 33242. Source: amazon.com, event: shopping, product: iPhone cell phone, timestamp: 01/04/08, 9:00 am, IP: 192.168.0.1,
Output: event: user 33242. Source: amazon.com, event: shopping, product: iPhone cell phone, timestamp: 01/04/08, 9:00 am, IP: 192.168.0.1, geolocation: los angeles, CA, keyword list: “iphone, cell phone, cell phone plan, 3G, buy a cell phone”, category: shopping/electronics

Referring again to FIG. 4, at 410, the list of features is mapped to nodes and information on a concept map. According to one embodiment of the present invention, a mapping to a keyword list is done by matching the content of a product or transaction description, or webpage. These initial features such as keywords and categories are then used to map the event to a subset of concept map features, thereby converting the event to a set of initial or seed concept nodes on a concept map event.

The following example illustrates the above mapping process.
Concept map event: user 33242. Source: amazon.com, event: shopping, concept nodes: iPhone, cell phone, cell phone plan, 3G, buy a cell phone, category: shopping/electronics.

At 415, a feature list on the concept map is created. The feature list indicates a user, a source, and a timestamp for each item in the list. An item in the feature list may comprise concept map properties at various levels of granularity, including top communities, categorization path for the seed or initial concept nodes, hubs or important concepts, and the like.

### Aggregating a User's Concept Map Features

According to one embodiment of the present invention, a user's concept map features are aggregated over time to identify important behavior patterns. According to one embodiment of the present invention, these features are aggregated to find regions of interest in the graph, while keeping the timing sequence. FIGS. 9-11 illustrate examples of the aggregation process. As a result of aggregating the user's concept map features over time, the user profile will comprise aggregate features such as the following:
a. High level categories
b. Aggregate category path for all the seed concept nodes
c. List of top communities
d. Aggregate list of concept nodes.

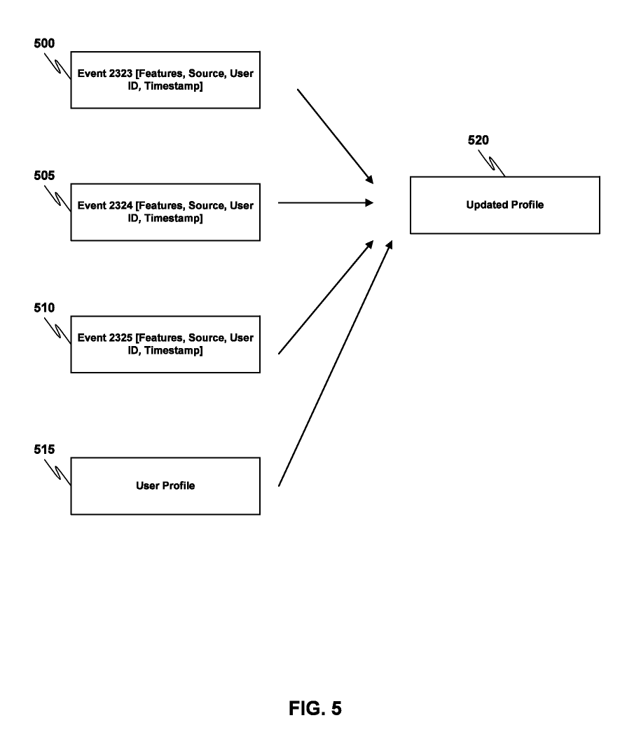

FIG. 5 is a block diagram that illustrates a method for aggregating a user's concept map history and updating a behavioral profile in accordance with one embodiment of the present invention. FIG. 5 provides more detail for reference numeral 205 of FIG. 2. FIG. 5 shows three events (500, 505, 510) and associated information representing a user's online event. The associated information for each event comprises a feature list, a source, a user ID, and a timestamp. The user's profile 515 is updated with aggregated information from the three events (500, 505, 510) to create an updated profile 520.

According to one embodiment of the present invention, behavioral edges are added to a concept map by aggregating each of multiple users' concept map events. According to one embodiment of the present invention, this aggregating of the features is done by updating behavioral edges and behavioral category edges between concepts as follows:

The score of a behavioral directional edge between concept A and concept B in the behavioral concept map is increased if all of the following conditions are satisfied:
a. there is an edge between concept A and concept B in the original concept map;
b. concept A and concept B are seed nodes of two different concept map events of the same user; and
c. The timestamp of the concept map event of concept B is after concept map event of concept A

The score of a categorical behavioral directional edge between concept A and concept B in the behavioral concept map is increased if all the following conditions are satisfied:
a. there is an edge between concept A and concept B in the original concept map;
b. concept A and concept B are in the category path of two different concept map events of the same user; and
c. the timestamp of the concept map event of concept B is after concept map event of concept A

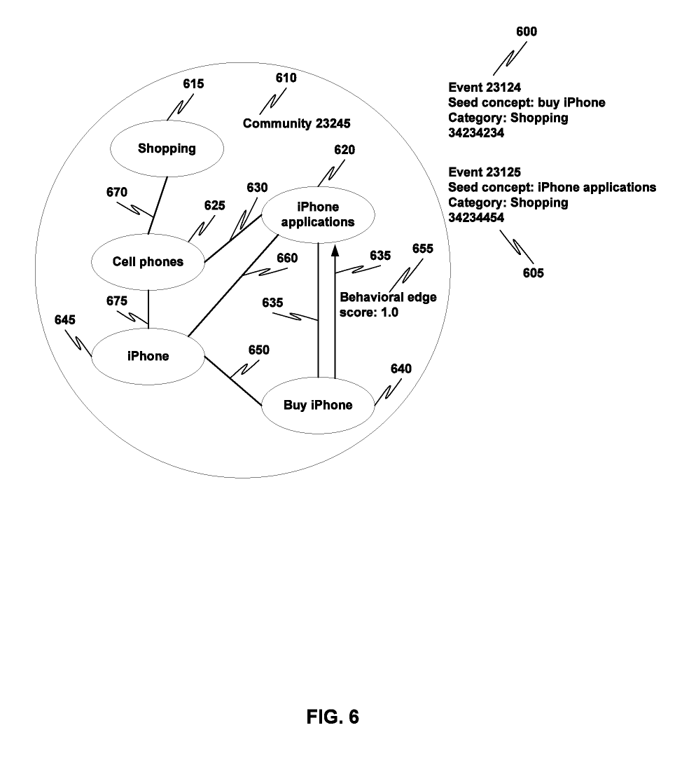

FIG. 6 shows an example of the seed concept aggregate. FIG. 6 shows a first event 600 with a seed concept of “buy iPhone,” and a later second event 605 with a concept of “iPhone applications.” There is already an edge 635 between the “iPhone applications” concept 620 and the “buy iPhone” concept in the concept map 610. Since all the conditions for increasing the score of behavioral directional edge 655 between concept 640 and concept 620 are met, the score of the edge is increased. The increased score of the edge in this case indicates an online user associated with the “buy iPhone” concept 640 has an increased likelihood of being interested in the “iphone applications” concept 600 in the future.

According to one embodiment of the present invention, the aggregating of the features is done as described above, except instead of the requirement that there be an edge between concept A and concept B in the original concept map, concept A and concept B are required to belong to the same community.

FIG. 7 is a block diagram that illustrates a method for aggregating a user's detected behaviors to generate a behavioral concept map in accordance with one embodiment of the present invention. FIG. 7 provides more detail for reference numeral 210 of FIG. 2. FIG. 7 shows multiple concept map profiles (700, 705, 710, 715) regarding particular users. The users' detected behaviors represented by the concept map profiles are aggregated to create an aggregate behavioral concept map 720.

FIG. 8 is a block diagram that illustrates a concept map in accordance with one embodiment of the present invention. FIG. 8 is an example of a sub graph of a concept map centered around the concept “Greek God” 816. As shown by the arcs connecting with the concept “Greek God” 816, the concept “Greek God” 816 is associated with the concepts “Perseus” 814, “Roman God” 804, “Percy” 802, “Ebe Moneter” 800, “Ancient Greek” 806, “Peloponnesian War” 808, “Ancient Olympic Games” 810, “Greek Culture” 812, “History for Kids” 818, “Discover Greece” 828, “Greek Myths” 826, “Greek Goddess” 838, “Greek Mythology” 836, Trojan War,” 822, “Demeter” 834, “Olympian” 832, “Greek & Roman” 830, and “Zeus” 824. Each of the edges between nodes in the subgraph represents a relationship between the respective concepts as described above.

FIGS. 9-11 are block diagrams that illustrate mapping online activities onto a concept map, and tracking behavior on the map in accordance with one embodiment of the present invention. FIGS. 9-11 illustrate how three online activities having different seed concepts can be mapped to the same higher level categories. FIGS. 9-11 also illustrate how a user's online activities may be aggregated over time.

As shown in FIG. 9, community 23245 (910) represents a subgraph of a concept map relating to diabetes. The online event is a search query for “type 2 diabetes.” The seed concept is determined to be “type 2 diabetes” 945. Using the categorization methodologies described above, the categorization path is determined to be “type 2 diabetes” “diabetes” “health,” with the lowest level category being the seed concept (type 2 diabetes), and the highest level category being the “health” concept 915.

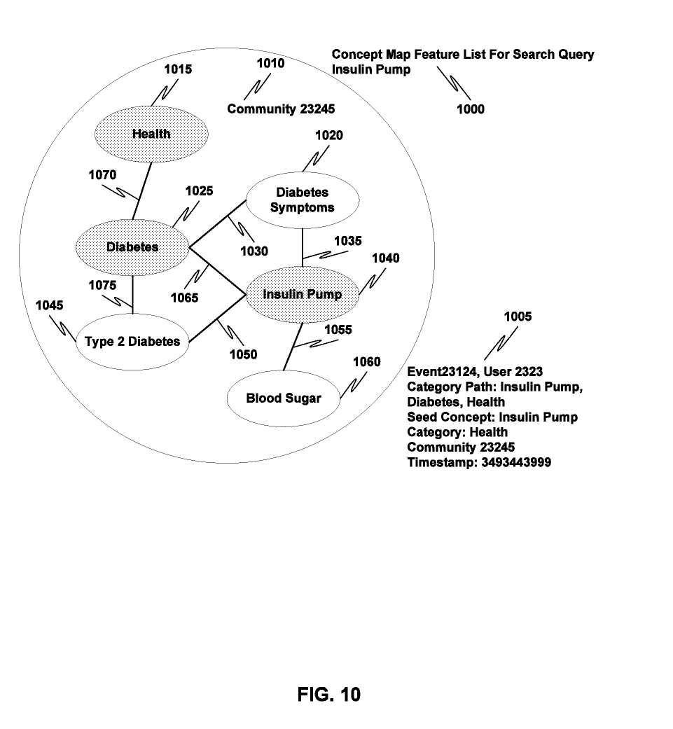

FIG. 10 shows the same subgraph of a concept map relating to diabetes as was depicted in FIG. 9. The online event shown in FIG. 10 is a search for “insulin pump.” The seed concept is determined to be “insulin pump” 1040. Using the categorization methodologies described above, the categorization path is determined to be “insulin pump” “diabetes” “health,” with the lowest level category being the seed concept (insulin pump), and the highest level category being the “health” concept 1015. Like the example illustrated in FIG. 9. The “health” concept 1015 is determined to be a high level category, and the “diabetes” concept 1025 is determined to be a medium level category.

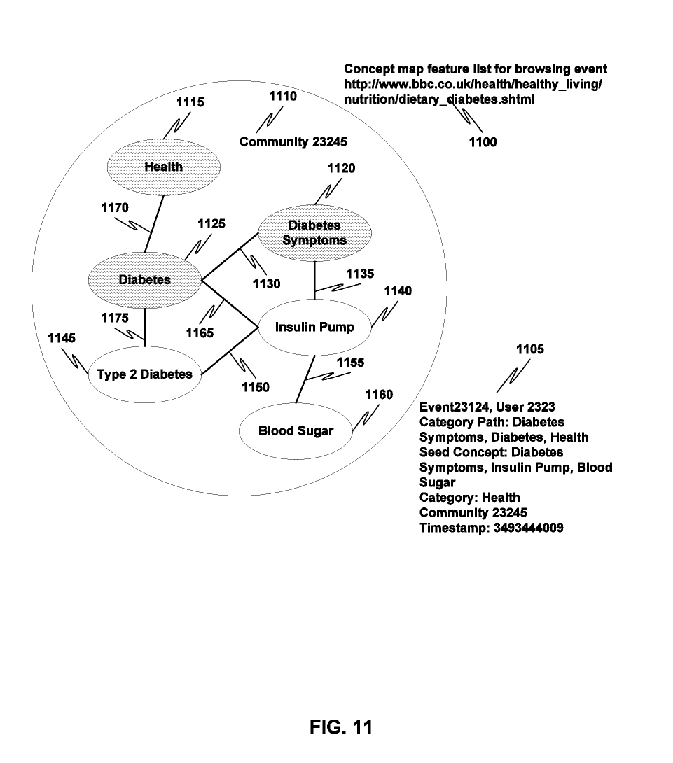

FIG. 11 shows the same subgraph of a concept map relating to diabetes as was depicted in FIGS. 9 and 10. The online event is the user browsing using the URL “http://www.bbc.co.uk/health/healthy_living/nutrition/dietary_diabetes.shtml.” The seed concept is determined to be “diabetes symptoms” 1120. Using the categorization methodologies described above, the categorization path is determined to be “diabetes symptoms” “diabetes” “health,” with the lowest level category being the seed concept (diabetes symptoms), and the highest level category being the “health” concept 1115. Like the examples illustrated in FIGS. 9 and 10. The “health” concept 1115 is determined to be a high level category, and the “diabetes” concept 1125 is determined to be a medium level category.

### Predicting Behavior

According to one embodiment of the present invention, the behavioral edges are tagged with different intentions or action categories. For example, if a majority of users make a purchase on moving from Concept A to Concept B, then such an edge could be tagged accordingly as a potential for sales related events. In general, multiple intentions can be assigned to a single behavioral edge, where there is a probability assigned to each such potential intention. According to one embodiment of the present invention, a next state and relevant concepts to a user are predicted based on a user aggregated profile and this concept map with behavioral edges.

According to one embodiment of the present invention, the time difference between a concept map event of concept B and a concept map event of concept A is limited to less than a predefined threshold. For example, if the predefined threshold between concept map events is ten days and concept B is associated with an online event that occurred more than ten days after an online event associated with concept A, a behavioral edge between concept A and concept B is unaffected.

According to one embodiment of the present invention, top next relevant concepts are identified using the following steps:
a. Identify the most recent top categories and communities of interest for the user
b. For the top K categories and communities, find top concepts that exist in the user profile
c. For these top concepts, identify the top next concepts by following behavioral edges and behavioral category edges.

According to one embodiment of the present invention, the above method is augmented to use CPC and CTR information to choose the top communities and the top next concepts that have the highest CPC and CTR information.

According to one embodiment of the present invention, a set of seed nodes on a concept map is used to identify a category and community of interest, and to find a next concept of interest based on different types of edges including behavioral edges. As an example, when a user browses a hotel website and makes a hotel reservation, the user profile is updated and includes community and concepts including hotel reservation. When the user continues browsing, the system suggests other concepts such as “air ticket,” “car rental,” that other users with the hotel reservation intention have done subsequent to making the hotel reservation.

### Filtering

According to one embodiment of the present invention, the user is provided with filtering capabilities, allowing the user to limit archiving and aggregation of user behavior based on category, source, time frame, communities, and concepts. For example, users may block the system from tracking their health concepts. As another example, users can indicate privacy-related concepts are not to be tracked.

According to one of the embodiment of the present invention, a user's events are tracked across communities, rather than at the concept level. In this embodiment, the accuracy of tracking the user's intention at a high-level increases for those instances in which the amount of behavioral data previously collected is scarce.

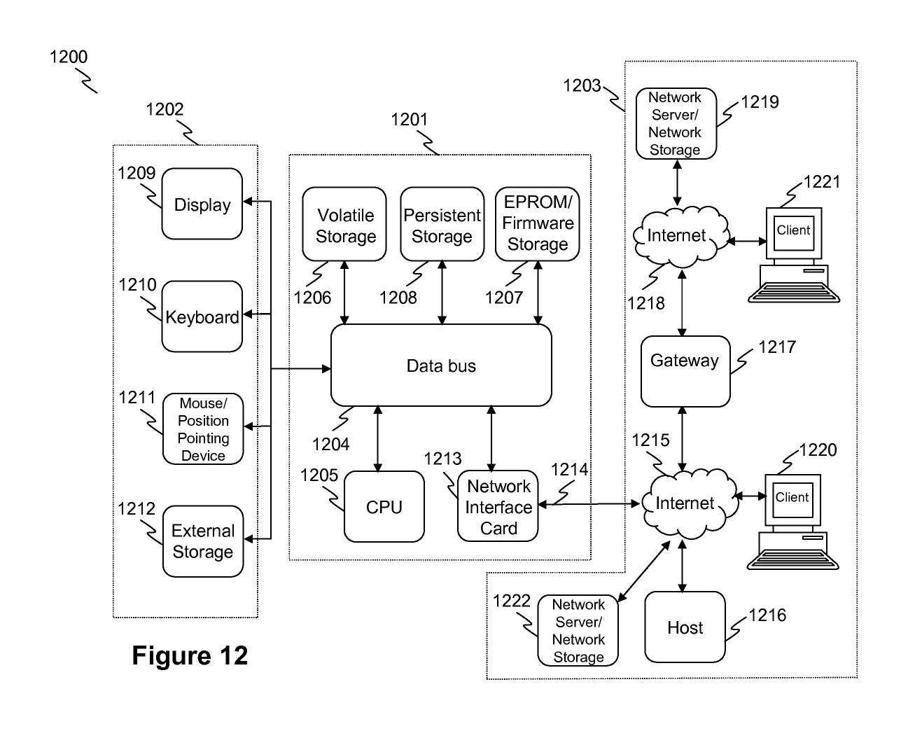

FIG. 12 is a block diagram of a computer system 1200 suitable for implementing aspects of the present invention. The system 1200 includes a computer/server platform 1201, peripheral devices 1202 and network resources 1203.

The computer platform 1201 may include a data bus 1204 or other communication mechanism for communicating information across and among various parts of the computer platform 1201, and a processor 1205 coupled with bus 1201 for processing information and performing other computational and control tasks. Computer platform 1201 also includes a volatile storage 1206, such as a random access memory (RAM) or other dynamic storage device, coupled to bus 1204 for storing various information as well as instructions to be executed by processor 1205. The volatile storage 1206 also may be used for storing temporary variables or other intermediate information during execution of instructions by processor 1205. Computer platform 1201 may further include a read only memory (ROM or EPROM) 1207 or other static storage device coupled to bus 1204 for storing static information and instructions for processor 1205, such as basic input-output system (BIOS), as well as various system configuration parameters. A persistent storage device 1208, such as a magnetic disk, optical disk, or solid-state flash memory device is provided and coupled to bus 901 for storing information and instructions.

Computer platform 1201 may be coupled via bus 1204 to a display 1209, such as a cathode ray tube (CRT), plasma display, or a liquid crystal display (LCD), for displaying information to a system administrator or user of the computer platform 1201. An input device 1210, including alphanumeric and other keys, is coupled to bus 1201 for communicating information and command selections to processor 1205. Another type of user input device is cursor control device 1211, such as a mouse, a trackball, or cursor direction keys for communicating direction information and command selections to processor 1204 and for controlling cursor movement on display 1209.

An external storage device 1212 may be connected to the computer platform 1201 via bus 1204 to provide an extra or removable storage capacity for the computer platform 1201. In an embodiment of the computer system 1200, the external removable storage device 1212 may be used to facilitate exchange of data with other computer systems.

Embodiments of the present invention are related to the use of computer system 1200 for implementing the techniques described herein. In an embodiment, the inventive system may reside on a machine such as computer platform 1201. According to one embodiment of the present invention, the techniques described herein are performed by computer system 1200 in response to processor 1205 executing one or more sequences of one or more instructions contained in the volatile memory 1206. Such instructions may be read into volatile memory 1206 from another computer-readable medium, such as persistent storage device 1208. Execution of the sequences of instructions contained in the volatile memory 1206 causes processor 1205 to perform the process steps described herein. In alternative embodiments, hard-wired circuitry may be used in place of or in combination with software instructions to implement embodiment of the present invention. Thus, embodiments of the present invention are not limited to any specific combination of hardware circuitry and software.

It should be noted that embodiments of the present invention are illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

The term “computer-readable medium” as used herein refers to any medium that participates in providing instructions to processor 1205 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1208. Volatile media includes dynamic memory, such as volatile storage 1206. Transmission media includes coaxial cables, copper wire and fiber optics, including the wires that comprise data bus 1204. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1205 for execution. For example, the instructions may initially be carried on a magnetic disk from a remote computer. Alternatively, a remote computer can load the instructions into its dynamic memory and send the instructions over a telephone line using a modem. A modem local to computer system 1200 can receive the data on the telephone line and use an infrared transmitter to convert the data to an infra-red signal. An infra-red detector can receive the data carried in the infra-red signal and appropriate circuitry can place the data on the data bus 1204. The bus 1204 carries the data to the volatile storage 1206, from which processor 1205 retrieves and executes the instructions. The instructions received by the volatile memory 1206 may optionally be stored on persistent storage device 1208 either before or after execution by processor 1205. The instructions may also be downloaded into the computer platform 1201 via Internet using a variety of network data communication protocols well known in the art.

The computer platform 1201 also includes a communication interface, such as network interface card 1213 coupled to the data bus 1204. Communication interface 1213 provides a two-way data communication coupling to a network link 1214 that is connected to a local network 1215. For example, communication interface 1213 may be an integrated services digital network (ISDN) card or a modem to provide a data communication connection to a corresponding type of telephone line. As another example, communication interface 1213 may be a local area network interface card (LAN NIC) to provide a data communication connection to a compatible LAN. Wireless links, such as well-known 802.11 a, 802.11 b, 802.11 g and Bluetooth may also used for network implementation. In any such implementation, communication interface 1213 sends and receives electrical, electromagnetic or optical signals that carry digital data streams representing various types of information.

Network link 1213 provides data communication through one or more networks to other network resources. For example, network link 1214 may provide a connection through local network 1215 to a host computer 1216, or a network storage/server 1217. Additionally or alternatively, the network link 1213 may connect through gateway/firewall 1217 to the wide-area or global network 1218, such as an Internet. Thus, the computer platform 1201 can access network resources located anywhere on the Internet 1218, such as a remote network storage/server 1219. On the other hand, the computer platform 1201 may also be accessed by clients located anywhere on the local area network 1215 and/or the Internet 1218. The network clients 1220 and 1221 may themselves be implemented based on the computer platform similar to the platform 1201.

Local network 1215 and the Internet 1218 both use electrical, electromagnetic or optical signals that carry digital data streams. The signals through the various networks and the signals on network link 1214 and through communication interface 1213, which carry the digital data to and from computer platform 1201, are exemplary forms of carrier waves transporting the information.

Computer platform 1201 can send messages and receive data, including program code, through the variety of network(s) including Internet 1218 and LAN 1215, network link 1214 and communication interface 1213. In the Internet example, when the system 1201 acts as a network server, it might transmit a requested code or data for an application program running on client(s) 1220 and/or 1221 through Internet 1218, gateway/firewall 1217, local area network 1215 and communication interface 1213. Similarly, it may receive code from other network resources.

The received code may be executed by processor 1205 as it is received, and/or stored in persistent or volatile storage devices 1208 and 1206, respectively, or other non-volatile storage for later execution. In this manner, computer system 1201 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the present invention will be apparent to those skilled in the art from consideration of the specification and practice of the present invention disclosed herein. Various aspects and/or components of the described embodiments may be used singly or in any combination in the online behavioral targeting system. It is intended that the specification and examples be considered as exemplary only, with a true scope and spirit of the present invention being indicated by the following claims.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A computer implemented method comprising:
correlating one or more online events of a user with one or more features of a pre-computed concept map representing a plurality of concepts, concept metadata, and relationships between the plurality of concepts;
aggregating a concept map history of the user to obtain online behavior over time;
aggregating online behavior of the user and one or more other users to obtain aggregated online user behavior; and
predicting future online behavior of the user based at least in part on the online behavior of the user and the aggregated online user behavior.

2. The method of claim 1, further comprising targeting one or more ads to the user based at least in part on the predicted future online behavior of the user.

3. The method of claim 2 wherein the one or more ads are based at least in part on an amount of time that has elapsed since one or more online events.

4. The method of claim 1 wherein the one or more online events comprise one or more of:
searching for a keyword;
browsing a webpage;
reading an email; and
shopping.

5. The method of claim 1 wherein the relationships comprise one or more of:
page co occurrence of concepts;
click through rates (CTRs) of advertisement;
co occurrence of concepts in advertiser campaigns; and
co occurrence of concepts in advertisement creatives.

6. The method of claim 1 wherein the one or more features comprise one or more of:
a keyword;
a category; and
geographical information.

7. The method of claim 1 wherein the aggregating a concept map history of the user further comprises storing the online behavior over time information in a profile for the user, the profile comprising one or more of:
high level categories;
aggregate category path for all seed concept nodes;
top communities; and
aggregate list of concept nodes.

8. The method of claim 1 wherein the aggregating online behavior of the user and one or more other users further comprises increasing a score of a behavioral edge between a first concept and a second concept in the concept map if:
an edge exists between the first concept and the second concept in the concept map;
the first concept and the second concept are seed nodes of two different concept map events of the same user; and
a timestamp of a concept map event of the first concept is after a concept map event of the second concept.

9. The method of claim 1 wherein the aggregating online behavior of the user and one or more other users further comprises increasing a score of a behavioral edge between a first concept and a second concept in the concept map if:
the first concept and the second concept belong to the same community;
the first concept and the second concept are seed nodes of two different concept map events of the same user; and
a timestamp of a concept map event of the first concept is after a concept map event of the second concept.

10. The method of claim 1, further comprising limiting the concept map history that is aggregated based at least in part on one or more of:
a category;
a source;
a time frame;
a community; and
a concept.

11. An apparatus comprising:
a pre-computed concept map representing concepts, concept metadata, and relationships between the concepts; and
a behavioral targeting engine configured to:
correlate one or more online events of a user with one or more features of the pre-computed concept map;
aggregate a concept map history of the user to obtain online behavior over time;
aggregate online behavior of the user and one or more other users to obtain aggregated online user behavior; and
predict future online behavior of the user based at least in part on the online behavior of the user and the aggregated online user behavior.

12. The apparatus of claim 11, further comprising an ad matching engine configured to target one or more ads to the user based at least in part on the predicted future online behavior of the user.

13. The apparatus of claim 12 wherein the one or more ads are based at least in part on an amount of time that has elapsed since one or more online events.

14. The apparatus of claim 11 wherein the one or more online events comprise one or more of:
searching for a keyword;
browsing a webpage;
reading an email; and
shopping.

15. The apparatus of claim 11 wherein the relationships comprise one or more of:
page co occurrence of concepts;
click through rates (CTRs) of advertisement;
co occurrence of concepts in advertiser campaigns; and
co occurrence of concepts in advertisement creatives.

16. The apparatus of claim 11 wherein the one or more features comprise one or more of:
a keyword;
a category; and
geographical information.

17. The apparatus of claim 11 wherein the behavioral targeting engine is further configured store the online behavior over time information in a profile for the user, the profile comprising one or more of:
high level categories;
aggregate category path for all seed concept nodes;
top communities; and
aggregate list of concept nodes.

18. The apparatus of claim 11 wherein the behavioral targeting engine is further configured to increase a score of a behavioral edge between a first concept and a second concept in the concept map if:
an edge exists between the first concept and the second concept in the concept map;
the first concept and the second concept are seed nodes of two different concept map events of the same user; and
a timestamp of a concept map event of the first concept is after a concept map event of the second concept.

19. The apparatus of claim 11 wherein the behavioral targeting engine is further configured to increase a score of a behavioral edge between a first concept and a second concept in the concept map if:
the first concept and the second concept belong to the same community;
the first concept and the second concept are seed nodes of two different concept map events of the same user; and
a timestamp of a concept map event of the first concept is after a concept map event of the second concept.

20. The apparatus of claim 11 wherein the behavioral targeting engine is further configured to limit the concept map history that is aggregated based at least in part on one or more of:
a category;
a source;
a time frame;
a community; and
a concept.

21. An apparatus comprising:
means for correlating one or more online events of a user with one or more features of a pre-computed concept map representing a plurality of concepts, concept metadata, and relationships between the plurality of concepts;
means for aggregating a concept map history of the user to obtain online behavior over time;
means for aggregating online behavior of the user and one or more other users to obtain aggregated online user behavior; and
means for predicting future online behavior of the user based at least in part on the online behavior of the user and the aggregated online user behavior.

24. A program storage device readable by a machine, embodying a program of instructions executable by the machine to perform a method, the method comprising:
correlating one or more online events of a user with one or more features of a pre-computed concept map representing a plurality of concepts, concept metadata, and relationships between the plurality of concepts;
aggregating a concept map history of the user to obtain online behavior over time;
aggregating online behavior of the user and one or more other users to obtain aggregated online user behavior; and
predicting future online behavior of the user based at least in part on the online behavior of the user and the aggregated online user behavior.
